(19) United States
(12) Patent Application Publication
(10) Pub. No.: US 2026/0200561 A1
(43) Pub. Date: Jul. 16, 2026

(54) FLOATING INTERVENTION VESSEL FOR TEMPORARILY DOCKING ON AN OFFSHORE WIND TURBINE PLATFORM AND ASSOCIATED INTERVENTION ASSEMBLY AND SYSTEM

(71) Applicant: TECHNIP ENERGIES FRANCE, NANTERRE (FR)

(72) Inventors: Cyrille DECHIRON, NANTERRE (FR); Patrice BASTET, NANTERRE (FR)

(21) Appl. No.: 19/135,618

(22) PCT Filed: Nov. 30, 2023
(86) PCT No.: PCT/IB2023/062079

§ 371 Date: Jun. 4, 2025

(30) Foreign Application Priority Data
Dec. 5, 2022 (FR) FR2212754

(51) Int. Cl. B63B 77/10; B63B 35/44; B63B 75/00; F03D 13/10

(52) U.S. Cl. CPC B63B 77/10; B63B 35/44; B63B 75/00; F03D 13/126; F03D 13/139; B63B 2035/442; F05B 2230/6102; F05B 2240/95

(57) ABSTRACT

Floating intervention vessel intended to temporarily moor itself on an offshore wind turbine platform, associated intervention assembly and facility The invention relates to a vessel comprising a float (80) and a wind turbine intervention assembly, carried by the float (80) The float (80) comprises a buoyant body (86) and a fastening baseplate (88) protruding from the buoyant body (86) along a fastening axis (A-A′) on a lower surface of the offshore wind turbine platform. The buoyant body (86) defines a ballast-receiving volume, the vessel comprising a ballast controller configured to control the amount of ballast received in the ballast-receiving volume to raise an upper contact surface (94) of the baseplate (88) to place it in contact with a lower surface of the offshore wind turbine platform, the float (80) being monohull.

The present invention relates to an offshore floating intervention vessel intended to temporarily moor itself on an offshore wind turbine platform to perform an installation and/or maintenance intervention on a wind turbine, the floating vessel comprising:
a float, intended to be at least partially submerged in a body of water;
a wind turbine intervention assembly, carried by the float, the intervention assembly comprising at least one lifting device configured to lift a wind turbine equipment.

Such a vessel is intended to perform mounting, dismounting and/or maintenance interventions on offshore wind turbines which are mounted on floating platforms.

Such an intervention vessel is particularly suitable for performing installation and/or maintenance operations in offshore wind farms located in water more than 60 m deep.

The installation and maintenance of the wind turbines can be carried out using an offshore platform, such as a fixed-base platform disclosed in document EP 2 275 340. Such a platform is particularly suited to shallow water where the wind turbines are attached to the bottom of the body of water using a mast support mounted permanently in the bottom of the body of water.

However, the vast majority of offshore wind turbine resources are found in water more than 60 m deep, where conventional seabed fastening is not economically or practically feasible. In order to exploit this potential, floating wind turbine platforms are used.

In such platforms, the mast of the wind turbine is carried by a floating base which is anchored by anchoring lines at the bottom of the body of water.

An example of a floating wind turbine platform comprises a floating base comprising several floating columns connected together by pontoons and/or lattices. The mast extends for example from the top of one of the columns.

Floating wind platforms create operation and maintenance (“O&M”) conditions that are more difficult for wind turbines, which requires new operation and maintenance strategies and technologies.

This is all the more the case when the floating wind platforms are seeing their installed power increase year by year, with installed powers of 8 MW, 12 MW, 15 MW or even now 20 MW. This is increasing the height of the mats (more than 100 m) and the length of the blades (more than 80 m).

Offshore wind turbines may require repeated heavy maintenance operations, given their expected long lifetimes (more than 25 years).

When these wind turbines are carried by floating bases, the maintenance operations may require disconnecting the mooring of the platform and towing to a port for maintenance with tall port cranes. These operations are lengthy and very expensive, causing a significant stoppage of production.

Offshore lifting solutions, at significant depth (for example 60 m to 120 m) exist but are not entirely satisfactory.

For example, jack-up maintenance platforms can be used. However, since these jack-up platforms are fixed relative to the seabed, while the wind turbine is arranged on a floating base, lifting operations are very complex to perform, given the relative deviation between the jack-up platform and the floating base due to the movements of the body of water.

Semi-submersible mounting and maintenance units also exist. These units can be moored to the floating wind turbine platform or placed in dynamic positioning relative to it (“Dynamic Positioning”). However, these units have their own roll, pitch, yaw, and heave movement, which also makes lifting operations difficult

Yet another solution is to place a crane on the floating base of the wind turbine. The crane moves together with the floating base, which considerably simplifies lifting operations. However, given the required size of the crane, its transshipment, its mounting on the floating base and its disassembly are heavy operations requiring specialized, rare, expensive ships.

One aim of the invention is therefore to provide an offshore intervention vessel, suitable for operations on offshore wind turbines requiring a high degree of positioning accuracy the intervention vessel being simple and inexpensive to operate.

To this end, the invention relates to an intervention vessel of the aforementioned type, characterized in that the float comprises a buoyant body and a fastening baseplate protruding relative to the buoyant body along a fastening axis on a lower surface of the offshore wind turbine platform, the buoyant body defining a ballast-receiving volume, the floating vessel comprising a ballast controller configured to control the amount of ballast received in the ballast-receiving volume in order to raise an upper contact surface of the baseplate to place it in contact with a lower surface of the offshore wind turbine platform, the float being monohull.

The intervention vessel according to the invention may comprise one or more of the following features, considered alone or according to any technically possible combination:
the upper contact surface of the baseplate is provided with an anchoring assembly, configured to eliminate the relative movement between the upper contact surface of the baseplate and the lower surface of the offshore wind turbine platform, the anchoring assembly comprising in particular at least one suction anchoring pad, and/or a magnetic anchoring pad and/or a friction anchoring pad;
the float has at least one docking fender located above the baseplate, the docking fender optionally protruding relative to the buoyant body along the fastening axis;
the float has an I-shaped section, taken in a vertical plane containing the fastening axis, or the float has a C-shaped section, taken in a vertical plane containing the fastening axis, the docking fender and the baseplate defining between them an intermediate space for receiving a structure of the offshore wind turbine platform;
the lifting device comprises at least one lifting and/or handling unit chosen from an intervention crane, a forklift, a wind turbine blade gripper, and/or a motion compensation device;
the lifting device comprises a fixed mast formed from a lattice of beams assembled together, the mast protruding vertically above the buoyant body;
the mast has a height greater than the height of the float, the mast advantageously having a center of gravity located at a height less than half of the height of the mast;
the transverse dimensions and/or the thicknesses of the beams of the lattice decrease from bottom to top along the mast;
the lifting device comprises a telescopic mast, deployable between a retracted configuration wherein its free end is arranged in the vicinity of the float, and an upward deployed configuration;
the telescoping mast axis is tiltable between a vertical configuration, a first configuration inclined at a non-zero angle relative to the vertical in a first direction and a second configuration inclined at a non-zero angle relative to the vertical in a second direction opposite the first direction;
the float comprises at least one propeller thruster arranged below the buoyant body and/or under the baseplate;
each horizontal section of the buoyant body has a maximum axial dimension, taken along the fastening axis, less than 0.75 times the maximum transverse dimension of the horizontal section, preferably less than 0.50 times the maximum transverse dimension of the horizontal surface, the maximum transverse dimension being taken perpendicular to the fastening axis.

The invention also relates to an offshore intervention assembly, comprising a ship having a hull defining at least one space for storing wind turbine equipment, and a floating vessel as defined above, wherein the floating vessel is movable relative to the ship between a transport position of the floating vessel to the offshore wind turbine platform, wherein the baseplate of the float is held secured against a lower surface of the hull and an intervention position, wherein the floating vessel is disposed away from the ship to intervene on an offshore wind turbine platform.

The intervention assembly according to the invention may comprise the following feature:
the ship comprises at least one rack for storing wind turbine equipment, and optionally at least one handling assembly having a handling member movable between a position for gripping wind turbine equipment in the storage rack and an intervention position outside the hull.

The invention also relates to an offshore facility comprising an offshore intervention assembly as defined above, and an offshore wind turbine platform, the floating vessel being movable through the body of water from its transport position to an intervention position wherein the baseplate is applied under a lower surface of the offshore wind turbine platform, the maximum axial dimension of each horizontal section of the buoyant body, taken along the fastening axis, being less than 90% of the maximum dimension of the offshore wind turbine platform, taken parallel to the same fastening axis.

The facility according to the invention may comprise the following feature:
the offshore wind turbine platform comprises a floating foundation having at least three floating columns and lower pontoons, connecting two-by-two the at least three floating columns, the lower pontoons defining at least a part of the lower surface of the floating wind turbine platform, the upper contact surface of the baseplate being engaged under the lower surface of a lower pontoon between two adjacent floating columns, the maximum transverse dimension of each horizontal section of the buoyant body being less than the distance horizontally separating the two adjacent floating columns or comprises a floating foundation formed from a barge with or without a central hole.

The invention will be better understood upon reading the following description, given solely by way of example, and made with reference to the accompanying drawings, in which:

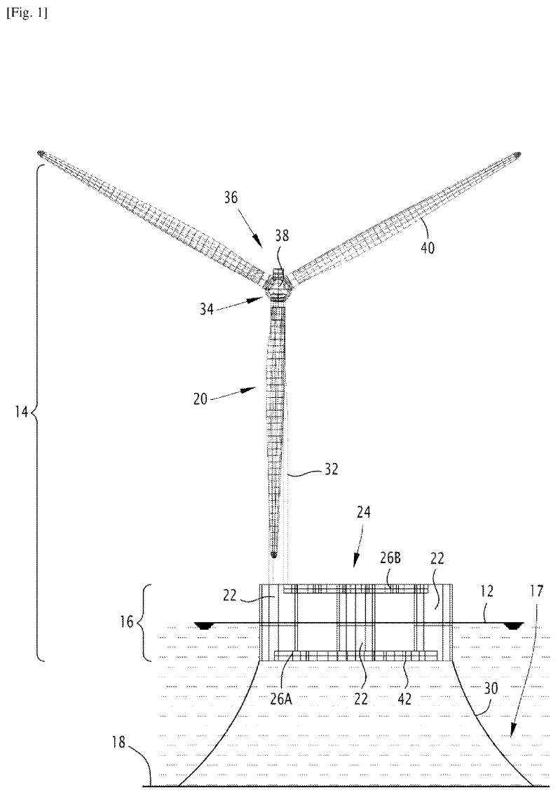

FIG. 1 is a front view of a floating wind turbine platform on which an intervention must be carried out using the intervention assembly according to the invention;

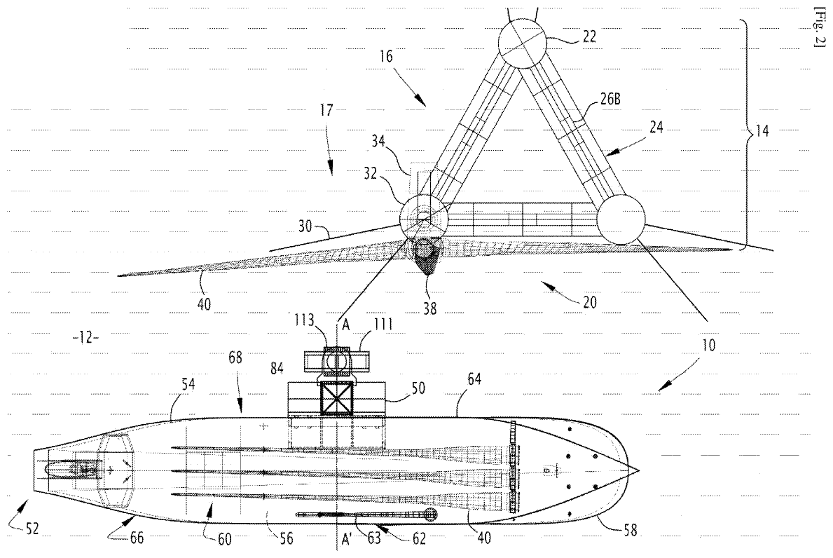

FIG. 2 is a top view of the floating wind turbine platform and the intervention assembly positioned in the vicinity of the floating wind turbine platform;

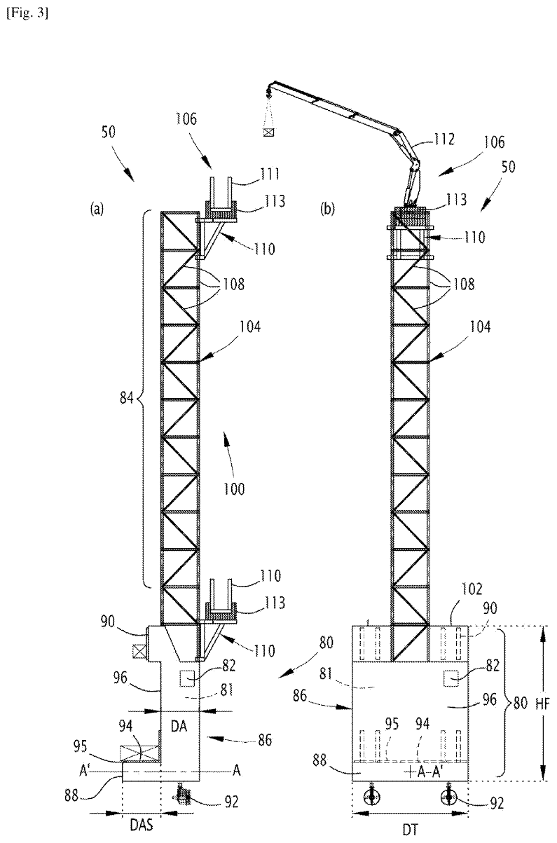

FIG. 3 is a side (b) view (a) of a floating intervention vessel of the intervention assembly according to the invention;

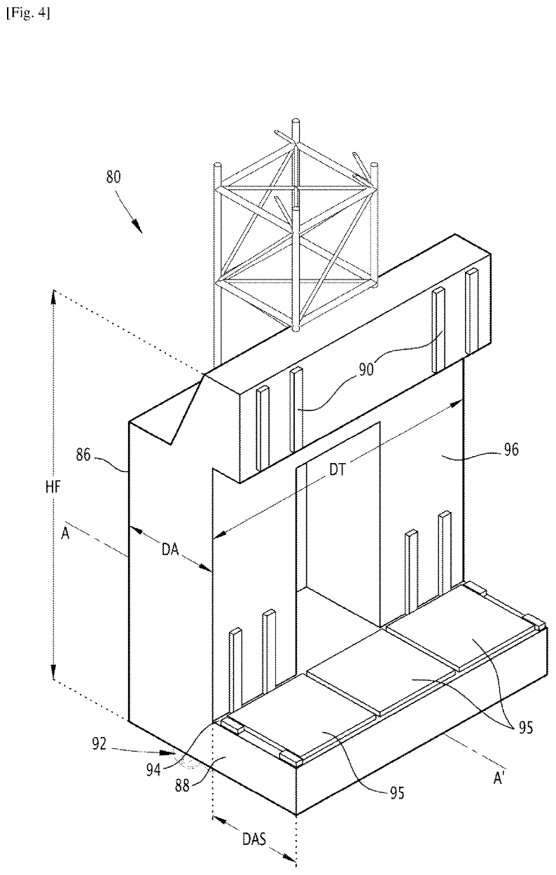

FIG. 4 is a three-quarter perspective view of a fastening baseplate of the floating vessel of FIG. 3 on the floating wind turbine platform, the baseplate being provided with fastening pads;

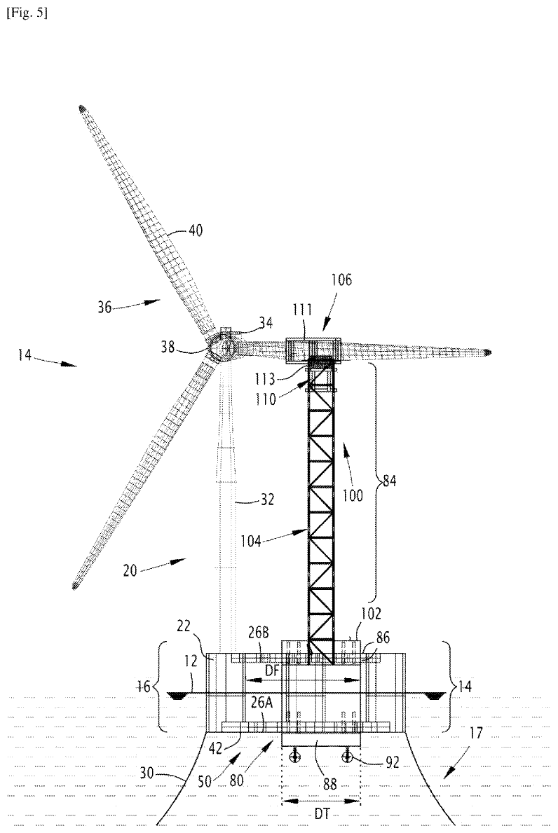

FIG. 5 is a view of a floating vessel provided with a fixed mast moored onto the offshore wind turbine platform, during an intervention on a wind turbine blade;

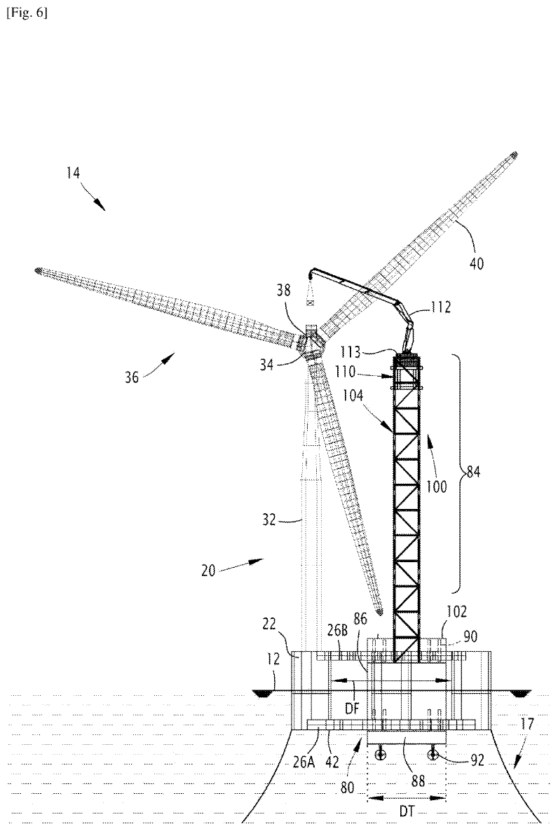

FIG. 6 is a view analogous to FIG. 5 during an intervention on the nacelle of the wind turbine;

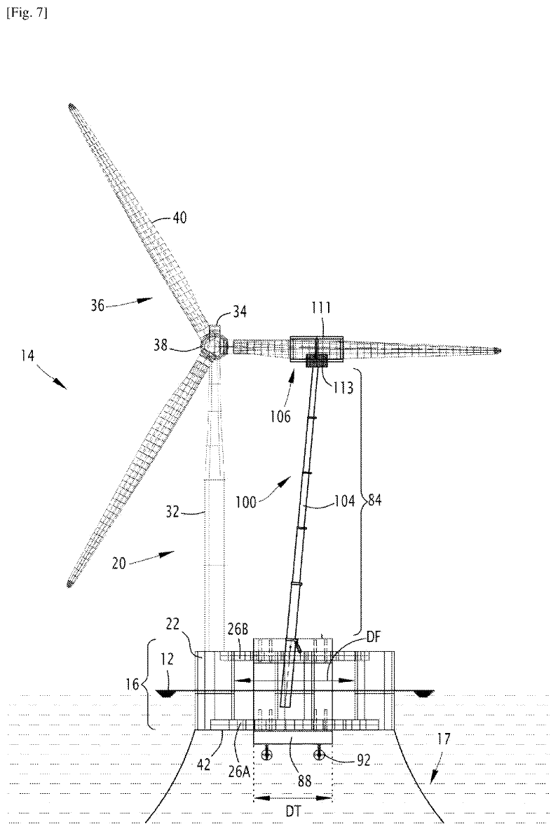

FIG. 7 is a view analogous to FIG. 5, the floating vessel being provided with a telescopic mast;

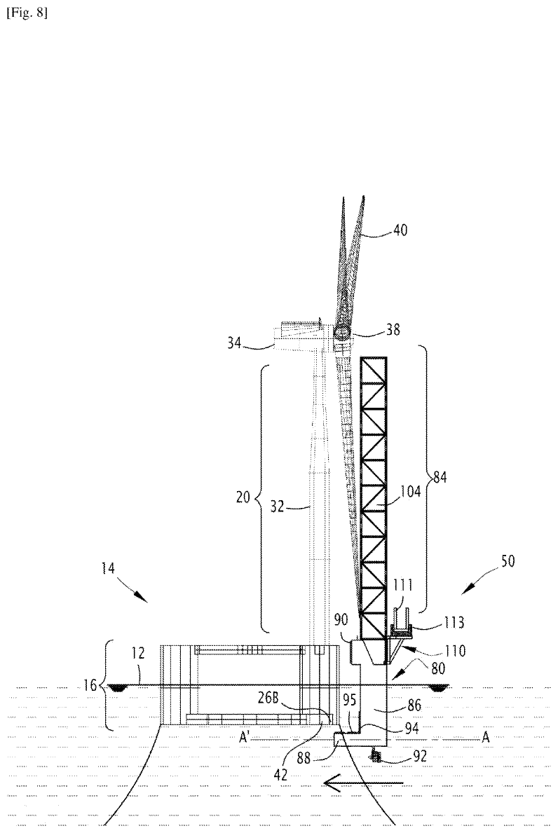

FIGS. 8 to 10 are side views successively showing the approach and mooring of the floating vessel on the offshore wind platform;

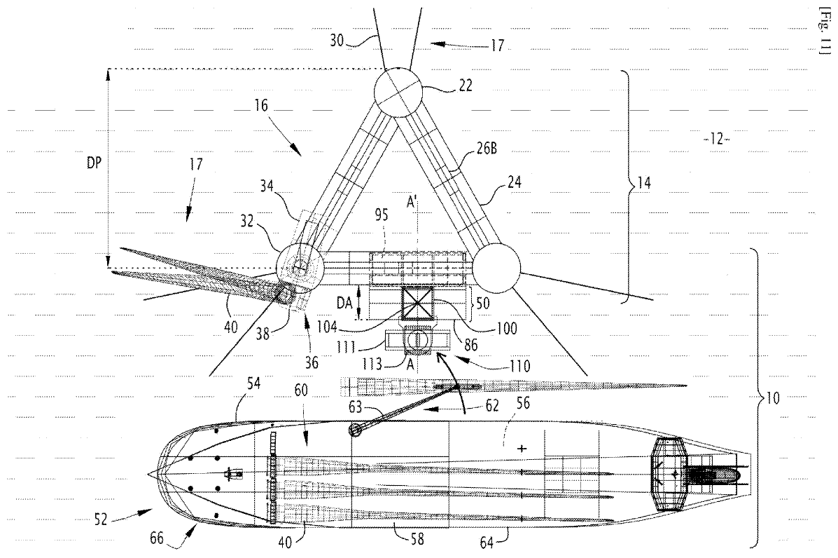

FIG. 11 is a top view analogous to FIG. 2 showing the transfer of a blade from the floating vessel to the transport vessel.

A first floating offshore intervention assembly 10 according to the invention is in particular shown in FIGS. 2 to 6 and 8 to 11.

The intervention assembly 10 floats on an body of water 12. It is intended to perform an installation and/or maintenance intervention on at least one floating offshore wind turbine platform 14 shown in [FIG. 1].

The offshore wind turbine platform 14 is for example located in an offshore wind farm on the surface of the body of water 12.

The body of water 12 near the offshore wind turbine platform 14 has a depth greater than 50 meters, and generally between 60 m and 1000 m.

The body of water 12 is for example an ocean, sea, lake, and/or river.

With reference to [FIG. 1], the wind turbine platform 14 comprises a floating foundation 16 for example with columns, or of the barge type, with or without a central hole, an anchoring assembly 17 anchoring the floating foundation 16 to the bottom 18 of the body of water 12 and a wind turbine 20 carried by the floating foundation 16.

In the example shown in the figures, the floating foundation 16 is a semi-submersible platform. In this example, it comprises at least three floating columns 22, structural elements 24 connecting the floating columns 22, and optionally a bridge (not shown). As a variant, as indicated above, the floating foundation 16 is formed of a prismatic barge, with or without a central hole.

In the particular example shown in the figures, the structural elements 24 here comprise lower pontoons 26A, connecting each pair of adjacent floating columns 22 to the bottom of the floating columns 22, upper pontoons 26B connecting each pair of adjacent floating columns 22 to the top of the floating columns 22. Alternatively (not shown), lower and/or upper pontoons radially connect each column to a central point of the foundation 16 and/or to a central floating column.

The floating columns 22 extend vertically. On the inside, they present a buoyancy volume that is at least partially filled with gas, providing buoyancy with the floating foundation 16. The buoyancy is adapted such that the floating foundation 16 is partially immersed in the body of water 12.

The anchoring assembly 17 comprises a plurality of anchoring lines 30 connecting each column 22 to the bottom 18 of the body of water 12. In the example of [FIG. 1], each floating column 22 is connected to at least one anchoring line 30, preferentially between two and four anchoring lines 30.

The wind turbine platform 14 is thus held in a horizontal position in the body of water 12.

The wind turbine 20 conventionally comprises a mast 32, a nacelle 34 rotatably mounted at the top of the mast 32, and a rotor 36, mounted to rotate relative to the nacelle 34 preferentially about a horizontal axis.

The rotor 36 comprises a central hub 38 and blades 40 projecting radially from the central hub 38, the blades 40 being removably attached to the hub 38.

The mast 32 is attached in this example to the top of a floating column 22, coaxially to the axis of one of the floating columns 22. Alternatively, the mast 32 is fixed non-coaxially to a floating column 22.

The floating columns 22 and advantageously the lower pontoons 26A define a lower surface 42 of the wind turbine platform 14. The lower surface 42 has at least one planar region intended for mooring the floating vessel 50 of the intervention assembly 10, as will be seen below.

The intervention assembly 10 is configured to be moved to the surface of the body of water 12 to come close to the offshore wind turbine platform 14 and perform an intervention.

The intervention is for example an installation of a wind turbine equipment, a maintenance of the wind turbine equipment and/or a dismantling of the wind turbine equipment. In particular, the wind turbine equipment is a blade 40, and the intervention is the installation of a blade 40, maintenance on a blade 40, or replacement of a blade 40.

As shown in FIGS. 2 and 11, the intervention assembly 10 comprises a floating intervention vessel 50, and a transport vessel, 52, intended for transporting the floating vessel 50 and wind turbine equipment for their mounting or replacement on the wind turbine 20 of the offshore wind turbine platform 14.

The transport ship 52 comprises a hull 54, defining a spacer 56 and a bridge 58. It comprises at least one rack 60 for storing wind turbine equipment, and a handling assembly 62.

The support rack 60 is for example arranged on the bridge 58 and/or in the spacer 56. It carries wind turbine equipment, for example blades 40, or mechanical or electrical equipment of the nacelle 34.

The hull 54 has a side wall 64 also referred to as “shell plating” and a bottom 66 also referred to as a “keel” defining a lower surface 68 on which the floating vessel 50 is intended to engage, the floating vessel 50 then being supported on the side wall 64, as will be seen below.

The handling assembly 62 comprises for example a crane and/or a lifting arm. It comprises at least one handling member 63, able to grip equipment on the rack 60, and to move it beyond the hull 54 to bring it to the floating vessel 50, when the latter is detached from the hull 54, as shown in [FIG. 11].

Preferably, the handling assembly 62 is of standard capacity in the offshore domain. It has a lifting capacity for example less than 1500 tons. Its achievable height is generally less than 40 meters. Thus, the ship 52 has a standard dimension, and is therefore easily available.

With reference to [FIG. 3], the floating vessel 50 comprises a monohull float 80, defining an interior volume 81 for receiving ballast, a ballast controller 82, configured to control the volume of ballast received in the interior ballast-receiving volume 81. The interior volume 81 is advantageously compartmentalized to ensure stability in the event of accidental seepage.

The floating vessel 50 further comprises an intervention assembly 84, mounted on the float 80, the intervention assembly 84 protruding upward from an upper surface of the float 80.

A monohull float is composed of a single floating hull, with or without a keel, as opposed to a multi-hull, such as a catamaran, an outrigger canoe, a trimaran or a quadrimaran. A monohull float is in particular devoid of a superstructure outside of water or in the air connecting several independent shells.

With reference to [FIG. 4], the monohull float 80 comprises a buoyant body 86 and a baseplate 88 that is not permanently attached to the offshore wind turbine platform 14 and/or to the ship 52 that protrudes relative to the buoyant body 86 along a horizontal fastening axis A-A′. The float 80 advantageously comprises a docking fender 90 and at least one thruster 92.

The float 80 is preferably of small thickness. For example, each horizontal section of the buoyant body 86, in particular the horizontal section of the buoyant body 86, which has a maximum area, has a maximum axial dimension DA along the fastening axis A-A′ less than 0.75 times the maximum transverse dimension DT of the buoyant body 86, taken perpendicularly to the fastening axis A-A′. Preferably, the maximum axial dimension DA is less than 0.50 times its maximum transverse dimension DT, preferably less than 0.40 times its maximum transverse dimension DT.

The buoyant body 86 advantageously has a height HF greater than its other dimensions, in particular to its maximum axial dimension DA and its maximum transverse dimension DT.

Likewise, the height HF of the buoyant body 86 is preferably greater than 2.0 times the maximum axial dimension DA, in particular greater than 3.0 times the maximum axial dimension DA. The height of the float 80 is also advantageously greater than 1.2 times the maximum transverse dimension DT.

Furthermore, the maximum axial dimension DA of the buoyant body 86 is less than 0.75 times, in particular 0.50 times and advantageously 0.20 times the maximum axial dimension DP of the floating wind turbine platform 14 (visible in [FIG. 11]), taken parallel to the fastening axis A-A′.

Also, in the case where the floating wind turbine platform 14 comprises a plurality of columns 22, the maximum transverse dimension DT is preferably less than the distance DF horizontally separating the floating columns 22 (visible in [FIG. 5]).

This makes it possible to remain at a safe distance from the anchoring lines 30 of the floating platform 14.

In the example shown in [FIG. 4], the buoyant body 86 of the monohull float 80 defines a central through-hole, opening parallel to the fastening axis A-A′. It thus has a continuous lower flotation region, two uprights protruding on either side of the lower flotation region and an upper region defining the upper surface of the float 80.

The baseplate 88 protrudes along the fastening axis A-A′ from the buoyant body 86, preferably from the lower end of the buoyant body 86.

The maximum axial dimension DAS of the baseplate 88, taken along the fastening axis A-A′ from the buoyant body 86, is preferably greater than 0.5 times the maximum axial dimension DA of the buoyant body 86, in particular greater than 0.8 times the maximum axial dimension DA of the buoyant body 86.

The baseplate 88 defines an upper contact surface 94 with the lower surface 42 of the offshore wind turbine platform, and/or with the lower surface 68 of the hull 54.

The area of the contact surface 94 is for example greater than at least 50% of the area of the horizontal section of the buoyant body 86 having a maximum area.

In the example shown in the figures, the maximum axial dimension DAS of the baseplate 88 is greater than 50% of the width of the lower surface 42 of the pontoon 26A on which the baseplate 88 applies, taken along the fastening axis A-A′.

As shown in [FIG. 4], the contact surface 94 is preferably equipped with at least one anchoring element 95 enabling the fastening to the lower surface 42, 68.

The anchoring assembly 95 for example comprises at least one anchoring pad to the lower surface 42, 68, preferably a plurality of anchoring pads. The or each anchoring pad is in particular an anchoring pad by suction of the volume of fluid arranged between the contact surface 94 and the lower surface 42, 68. Advantageously, the suction anchor pad then comprises a peripheral seal carried by the contact surface 94 and intended to be applied in a sealed manner to the lower surface 42, 68. The volume of fluid present inside the peripheral seal between the contact surface 94 and the lower surface 42, 68 is then intended to be sucked in order to activate the anchoring, which in particular results from the pressure of the surrounding water applying a connection force.

Alternatively or additionally, at least one anchoring pad is a friction anchoring pad and/or a magnetic anchoring pad.

In the embodiment shown in the figures, the baseplate 88 is fixed relative to the buoyant body 86 and protrudes permanently from the buoyant body 86. In one variant (not shown), the baseplate 88 is retractable from a deployed configuration relative to the buoyant body 86 to a retracted position inside the buoyant body 86.

In this example, given the geometry of the floating foundation 16, the or each docking fender 90 protrudes from the buoyant body 86 along the fastening axis A-A′ above and vertically offset from the baseplate 88. Here it extends from the upper end of the buoyant body 86. Alternatively, for other floating foundations 16, the or each docking fender 90 is flush with the buoyant body 86.

The docking fender 90 comprises for example an elastomer block capable of coming into contact with the upper pontoon 26B.

The baseplate 88 and the docking fender 90 thus delimit between them an interspace 96 able to allow the insertion of a lower pontoon 26A of the platform 14. Advantageously, other elastomer blocks are present in this interspace to dampen the docking of the lower pontoon 26A.

In the particular example shown in [FIG. 3], the float 80 advantageously has, in side view, a C-shaped profile.

Preferably, the float 80 is also provided with a mooring assembly (not shown) comprising at least one mooring line configured to deploy toward the offshore wind turbine platform 14 or to the transport ship 52 and to ensure robust attachment to the offshore wind turbine platform 14. This reinforces and secures in particular the out-of-water connection, at the upper part of the platform 14.

Each thruster 92 is mounted under the buoyant body 86 and/or under the baseplate 88. It comprises for example at least one rotating propeller mounted in a tubular casing.

Each thruster 92 is preferably mounted to rotate about a vertical axis, for example with an angular stroke of 360°.

The thruster(s) 92 are configured to move the vessel 50 horizontally in the body of water 12, in particular between a transport position moored on the ship 52, shown in FIG. 2, and the intervention position, wherein the floating vessel is moored under the offshore wind turbine platform 14, as shown in [FIG. 11].

The ballast-receiving volume 81 is for example delimited in the buoyant body 86 and/or in the attachment baseplate 88. It is advantageously completed with a fixed volume of ballast, preferably located at the keel in order to improve the autonomous navigation stability between the transport ship 52 and the floating platform 14.

At rest, the ballast-receiving volume 81 is at least partially filled with a gas such as air. Here the ballast is formed from water coming from the body of water 12.

The ballast controller 82 comprises at least one pump configured to pump ballast into the ballast-receiving volume 81 and thus reduce the buoyancy of the floating vessel 50, or to pump out ballast present in the ballast-receiving volume 81 and thus increase the buoyancy of the floating vessel 50.

Thus, the ballast controller 82 is configured to stabilize the float 80 and control the draught of the float 80 between a lower configuration, wherein the baseplate 88 is able to pass under the lower surface 42, 68, and an upper configuration, wherein the contact surface 94 of the mooring baseplate 88 is able to apply under the lower surface 42, 68, advantageously exerting an upward force on the lower surface 42, 68.

In the example shown in FIGS. 3 to 6, the intervention assembly 84 comprises a device 100 for lifting wind turbine equipment carried by the float 80 and, optionally, a storage 102 of wind turbine equipment present on the float 80.

In the example shown in this figure, the lifting device 100 comprises a fixed mast 104, and at least one lifting and/or handling unit 106 carried by the mast 104.

Here the mast 104 is formed of a lattice of beams 108. Preferably, the thickness of the beams 108 forming the mast 104 decreases from bottom to top along the mast 104.

This makes it possible for the structure of the mast 104 to become lighter as it moves toward its tip, and to lower the center of gravity of the intervention vessel 50. Preferably, the center of gravity of the mast 104 is lowered at least half of the height of the mast 104, for example at four-tenths of the height of the mast 104.

The lifting and/or handling unit(s) 106 comprise for example a forklift 110, movably mounted along the mast 104, and/or an intervention crane 112 movably mounted along the mast 104 preferably in the forklift 110.

The forklift 110 is for example movable between a lower position located opposite the storage 102, and an upper position of intervention on the wind turbine 20 as visible in [FIG. 3].

The intervention crane 112 is operable from the mast 104, for example to intervene at the nacelle 34.

The forklift 110 ensures the vertical movement. It is preferably provided with a blade gripper 111.

Advantageously, the forklift 110 and/or the intervention crane 112 are provided with a three-dimensional motion compensation table 113 to compensate for any deviations between the forklift 110, and the wind turbine 20, in particular in translation in a horizontal plane, and preferably along six axes. The vertical compensation can advantageously be carried out by the forklift 110.

A method of intervention on an offshore wind turbine platform 14, using the intervention assembly 10, will now be described.

This method will be described for example for the replacement of a blade 40 of the wind turbine 20. Alternatively, the intervention relates to another equipment of the wind turbine 20, for example equipment of the nacelle 34 and/or of the mast 32.

Initially, the equipment intended for the wind turbine 20 is loaded into the ship 52, for example being arranged in the racks 60 present in the spacer 56 or on the bridge 58.

The intervention vessel 50 is then attached to the hull 54 of the ship 52. To do this, the ballast controller 82 is activated to introduce ballast into the ballast-receiving volume 81 and to move the contact surface 94 to a height lower than the height of the lower surface 68 of the ship 52.

The thruster 92 is then activated to move the baseplate 88 and to move it under the lower surface 68 of the hull 54. Then, the ballast controller 82 is controlled to extract ballast from the ballast-receiving volume 81.

Under the effect of deballasting, the contact surface 94 rises and applies to the lower surface 68. It exerts an upward force on the lower surface 68. Furthermore, the anchoring assembly 95 of the contact surface 94 on the lower surface 68 is activated, for example by suction between these surfaces at the anchoring pads 95, or by activating the pads by friction or the magnetic pads.

The docking fender 90 is applied laterally to the side wall 64 of the hull 54. The mooring assembly is then put into place to finalize the holding in position of the floating vessel 50 on the hull 54 of the ship.

The floating vessel 50 having a float 80 having a maximum axial dimension and a transverse dimension as specified above, the float 80 has a small footprint in the body of water 12 relative to the ship 52, so that it is easily secured to the hull 54 of the ship 52 allowing its easy transport to the vicinity of the offshore wind turbine platform 14, even over long distances.

As shown in [FIG. 2], when the ship 52 arrives near the offshore wind turbine platform 14, for example at a distance of less than 500 m from the offshore wind turbine platform 14, in particular between 40 m and 300 m, the mooring assembly is disconnected and the anchoring assembly 95 is deactivated.

The ballast controller 82 is again controlled to introduce ballast into the ballast-receiving volume 81.

Under the effect of the introduction of the ballast, the float 80 separates from the hull 54 of the ship 52.

The thrusters 92 are then activated to move the floating vessel 50 towards the offshore wind turbine platform 14. The thrusters 92 are also activated to orient the baseplate 88 with its attachment axis A-A′ perpendicular to the axis of a lower pontoon 26A, as shown by [FIG. 8].

If necessary, the ballasting is adjusted using the ballast controller 82 so that the contact surface 94 of the baseplate 88 is located at a height lower than the height of the lower surface 42 of the floating wind turbine platform 14, in particular at a height lower than that of the lower surface of the pontoon 26A.

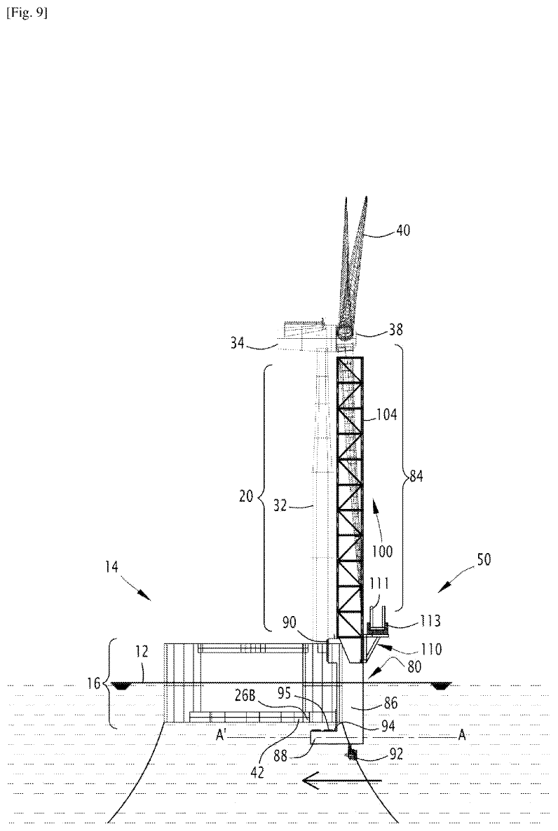

With reference to [FIG. 9], the baseplate 88 then passes below the lower pontoon 26A until the docking fenders 90 come into contact with the upper pontoon 26B.

The lower pontoon 26A is housed in the interspace 96 between the contact surface 94 of the baseplate 88 and the docking fender 90.

The float 80 is positioned opposite the pontoons 26A, 26B, between the columns 22.

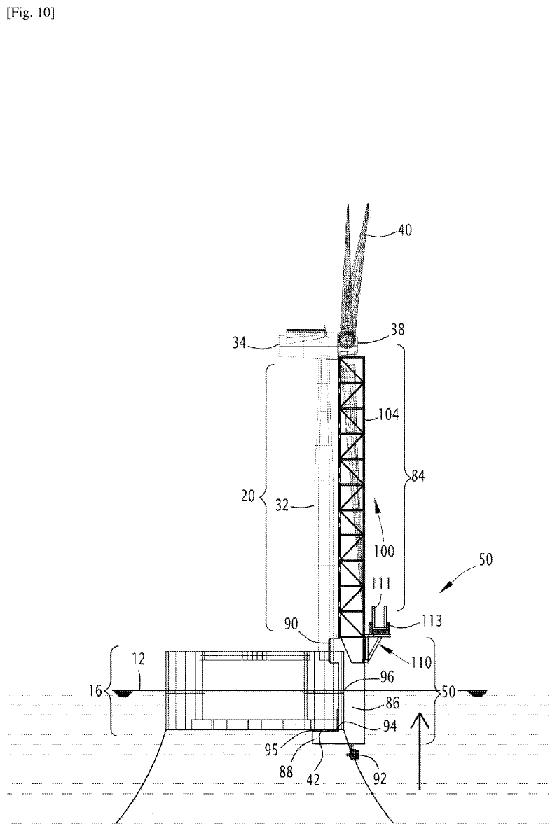

Then, the ballast controller 82 is reactivated to extract ballast from the ballast-receiving volume 81. As shown in [FIG. 10], this causes the contact surface 94 that is applying under the lower surface 42 to rise, and acts as previously to exert a force directed upward on this surface 42. This force is generally greater than at least 80%, preferably greater than the weight of the wind turbine equipment intended to be raised, in particular greater than the weight of the wind turbine blade 40.

The anchoring assembly 95 is then activated as described above. This being done, the mooring assembly is connected to the offshore wind turbine platform 14, advantageously at the upper pontoon 26B.

The floating vessel 10 is thus secured to the floating foundation 16 of the offshore wind turbine platform 14.

Considering the dimensions of the float 80 as described above, the float 80 is secured to the movement of the floating foundation 16 and moves together with it, without heave, or take-off.

The lifting device 100 then protrudes relative to the float 80 directly opposite the mast 32 of the wind turbine 20.

In the event of a blade 40 being changed, the forklift 110 is then placed in an upper position visible in [FIG. 5] to grip the blade 40. It is optionally moved angularly to orient itself in the axis of the blade 40 and transversely to come closer to the bolting plate of the blade 40 on the hub of the rotor.

Alternatively, the carriage 110 is placed at the center of gravity of the blade 40. The nacelle 34 is oriented in azimuth to present the blade 40 in the same alignment as the gripper of the forklift 110.

Optionally, when a three-dimensional compensation device is used, it takes up the relative movements due in particular to the residual flexibility of the connection between the floating foundation 16 and the float 80 as well as to the flexibility between the mast 32 of the wind turbine 20 and the mast 104 of the lifting device 100.

The blade 40 is then separated from the central hub 38, so as to be placed on the forklift 110 which is lowered back down into its lower position.

Referring to [FIG. 11], the ship 52 then approaches the floating vessel 50 and the handling assembly 62 of the ship 52 is controlled to grip the blade 40 that has been removed from the wind turbine 20 and place it in a rack 60 located in the spacer 56 or on the bridge 58.

A replacement blade 40 is then grasped by the handling assembly 62, then loaded onto the forklift 110 in its lower position. The forklift 110 is then raised to the height of the central hub 38 of the wind turbine 20, to allow the replacement of the replacement blade 40.

Alternatively, as shown in [FIG. 6], the intervention crane 112 is activated to be moved vertically (for example on the forklift 110 as a replacement for the gripper 111) and placed opposite the nacelle 34 and intervene on another equipment of the nacelle.

In the interventions that have just been described, the float 80 is attached to a lower pontoon 26A between two floating columns 22, and its maximum transverse dimension DT is less than the distance DF horizontally separating the floating columns 22 (see [FIG. 5]). As indicated above, this limits the risk of interference with the anchoring lines 30.

Thus, it is possible to have the lifting device 100 placed at the appropriate position relative to the wind turbine 20, while retaining very effective securing of the float 80 onto the floating foundation 16 of the wind turbine 20. The appropriate position is as close as possible to the mast 32 in the case of use of the intervention crane 112. For the replacement of a blade 40, the appropriate position is at the distance of the mast 32 adapted so that the mast 104 is aligned with the position of the center of gravity of the blade 40.

This limits the undesirable deviations between the lifting and/or handling units 106 and the wind turbine 20.

Thus, by virtue of the floating vessel 50 according to the invention, it is possible to perform complex maintenance operations, in particular the replacement of blades 40 of wind turbines 20 or heavy nacelle equipment 34 on an offshore wind turbine platform 14 carrying a high-power wind turbine, installed very high, for example more than 100 m above the surface of the body of water 12.

These interventions 20 can be done without returning to a port on the coast, which reduces the production time and stopping of production, and therefore the cost.

The lifting device 100 is directly secured to the offshore wind turbine platform 14 using the floating vessel 50, as if it was mounted directly on the offshore wind turbine platform 14, given the small relative deviations between the offshore wind turbine platform 14 and the floating vessel 50.

It is therefore not necessary to mount/dismount a large-size intervention crane on the offshore wind turbine platform 14, the latter being present on the floating vessel 50. The use of a specific ship and/or of a large-capacity crane is therefore not useful since the lifting device 100 is already present on the floating vessel 50.

The floating vessel 50 according to the invention therefore makes it possible to simply bring to the offshore wind turbine platform 14 a high-capacity lifting device 100, while retaining the advantage of remaining integral in movement with the offshore wind turbine platform 14, and in particular with the wind turbine 20.

The floating vessel 50 can move autonomously from the ship 52 which transports it in the vicinity of the platform 14 toward the offshore wind turbine platform 14 thanks to its thrusters 92.

Furthermore, once fixed to the offshore wind turbine platform 14, the floating vessel 50, although having a float 80 of reduced dimensions, and therefore with little inertia, benefit from the intrinsic stability of the floating foundation 16 of the offshore wind turbine platform 14. The latter being sized to withstand severe storms, this guarantees the stability of the floating wind turbine platform 14, even when the floating vessel 50 is moored to it.

Thus, the transportation of the floating vessel 50 can be carried out with a simple ship 52 currently used, with a relatively fast transport time. Furthermore, the dimensions of the float 80 avoid having to modify the design of the mast 32 of the wind turbine 20, since the floating vessel 50 can be moored to the floating foundation 16 at a position adapted to the intervention.

The mooring of the float 80 on the floating foundation 16 is also very simple, in particular when the latter comprises pontoons 26A, 26B, the C-shape of the float 80 in side view making it possible to house the lower pontoons 26A, once the docking fender 90 is applied to the upper pontoon 26B.

In a variant shown in FIG. 7, the lifting device 100 does not comprise a fixed mast 104. It comprises a telescopic mast 104 between a retracted position, wherein the free end of the mast 104 is in the vicinity of an upper end of the float 80, and a deployed position protruding upward relative to the upper end of the float 80.

The telescopic mast 104 is provided at its free end with the or each lifting and/or handling unit 106, for example a gripper 111 or an intervention crane 112 and advantageously, a motion compensation device 113.

As shown in [FIG. 7], in the case of assembly or blade replacement 40, the telescopic mast 104 is deployed vertically so that the gripper 111 in the deployed position receives the blade 40.

The mast 104 is inclined relative to the vertical for example by an angle of between 1° and 15° moving away from the mast 32 of the wind turbine 20. This moves the gripper 111 away from the mast 32 so that it is naturally placed near the center of gravity of the blade 40.

Preferably, the vertical position is not used during the lifting of the masses because the inclination makes it possible to compensate for the mechanical play of the telescopic mast 104 and stabilizes the position of the top.

Alternatively, for example on the nacelle 34, the telescopic mast 104 is inclined relative to the vertical for example by an angle of between 1° and 15° to allow the intervention crane 112 to approach the nacelle 34.

This makes it possible to approach the top of the telescopic mast 104 of the nacelle 34, without having to bring the floating vessel 50 closer to the mast 32.

In other words, the initial adjustment of the angle of the telescopic mast 104, and then the deployment of the telescopic length, alternatively makes it possible to move the top of the mast 104 away from the mast 32 of the wind turbine 20 in order to be at the center of gravity of the blade 40, or on the contrary, to bring the top of the mast 104 closer to the mast 32 of the wind turbine 32, to be closest to the nacelle 34 in order to carry out the lifting of its components.

The use of a telescopic mast 104 lowers the center of gravity of the floating vessel 50 when the telescopic mast 104 is in its retracted position. This is useful in particular during the transportation of the floating vessel 50 on the ship 52, and during its autonomous movement through the body of water 12 from the hull 54 of the ship 52 to the offshore wind turbine platform 14.

1. An offshore intervention floating vessel (50), intended to temporarily moor itself on an offshore wind turbine platform (14) to perform an installation and/or maintenance intervention on a wind turbine (20), the floating vessel (50) comprising:
a float (80), intended to be at least partially submerged in a body of water (12);
a wind turbine (20) intervention assembly (84), carried by the float (80), the intervention assembly (84) comprising at least one lifting device (100) configured to lift a wind turbine equipment,
characterized in that the float (80) comprises a buoyant body (86) and a fastening baseplate (88) protruding relative to the buoyant body (86) along a fastening axis (A-A′) on a lower surface (42) of the offshore wind turbine platform (14), the buoyant body (86) defining a ballast-receiving volume (81), the floating vessel (50) comprising a ballast controller (82) configured to control the amount of ballast received in the ballast-receiving volume (81) to move upward an upper contact surface (94) of the baseplate (88) to place it in contact with a lower surface (42) of the offshore wind turbine platform (14), the float (80) being monohull.

2. The floating vessel (50) according to claim 1, wherein the upper contact surface (94) of the baseplate (88) is provided with an anchoring assembly (95), configured to eliminate the relative movement between the upper contact surface (94) of the baseplate (88) and the lower surface (42) of the offshore wind turbine platform (14), the anchoring assembly (95) comprising in particular at least one suction anchoring pad, and/or a magnetic anchoring pad and/or a friction anchoring pad.

3. The floating vessel (50) according to any of claims 1 or 2, wherein the float (80) has at least one docking fender (90) located above the baseplate (88), the docking fender (90) optionally protruding relative to the buoyant body (86) along the fastening axis (A-A′).

4. The floating vessel (50) according to claim 3, wherein the float (80) has an L-shaped section, taken in a vertical plane containing the fastening axis (A-A′), or wherein the float (80) has a C-shaped section, taken in a vertical plane containing the fastening axis (A-A′), the docking fender (90) and the baseplate (88) defining between them an intermediate space (96) for receiving a structure of the offshore wind turbine platform (14).

5. The floating vessel (50) according to any of the preceding claims, wherein the lifting device (100) comprises at least one lifting and/or handling unit (104) selected from an intervention crane (112), a forklift (110), a wind turbine blade gripper (111), and/or a motion compensation device (113).

6. The floating vessel (50) according to any of the preceding claims, wherein the lifting device (100) comprises a fixed mast (104) formed from a lattice of beams (108) assembled together, the mast (104) protruding vertically above the buoyant body (86).

7. The floating vessel (50) according to claim 6, wherein the mast (104) has a height greater than the height of the float (80), the mast (104) advantageously having a center of gravity located at a height less than half of the height of the mast (104).

8. The floating vessel (50) according to any of claims 6 or 7, wherein the transverse dimensions and/or thicknesses of the beams (108) of the lattice decrease from bottom to top along the mast (104).

9. The floating vessel (50) according to any of claims 1 to 5, wherein the lifting device (100) comprises a telescopic mast (104), deployable between a retracted configuration wherein its free end is arranged in the vicinity of the float (80), and an upward deployed configuration.

10. The floating vessel (50) according to claim 9, wherein the axis of the telescoping mast (104) is tiltable between a vertical configuration, a first configuration inclined at a non-zero angle relative to the vertical in a first direction and a second configuration inclined at a non-zero angle relative to the vertical in a second direction opposite the first direction.

11. The floating vessel (50) according to any of the preceding claims, wherein the float (80) comprises at least one propeller thruster (92) arranged below the buoyant body (86) and/or under the baseplate (88).

12. The floating vessel (50) according to any of the preceding claims, wherein each horizontal section of the buoyant body (86) has a maximum axial dimension, taken along the fastening axis (A-A′), less than 0.75 times the maximum transverse dimension of the horizontal section, preferably less than 0.50 times the maximum transverse dimension of the horizontal surface, the maximum transverse dimension being taken perpendicular to the fastening axis (A-A′).

13. An offshore intervention assembly (10), comprising a ship (52) having a hull (54) defining at least one storage space for wind turbine equipment, and a floating vessel (50) according to any of the preceding claims, wherein the floating vessel (50) is movable relative to the ship (52) between a transport position of the floating vessel (50) to the offshore wind turbine platform (14), wherein the baseplate (88) of the float (80) is held secured against a lower surface (68) of the hull (54) and an intervention position, wherein the floating vessel is disposed away from the ship (52) to intervene on an offshore wind turbine platform (14).

14. The offshore intervention assembly (10) according to claim 13, wherein the ship (52) comprises at least one rack (60) for storing wind turbine equipment, and optionally at least one handling assembly (62) having a handling member (63) movable between a position for gripping wind turbine equipment in the storage rack (60) and an intervention position outside the hull (54).

15. An offshore facility comprising an offshore intervention assembly (10) according to one of claims 13 or 14, and an offshore wind turbine platform (14), the floating vessel (50) being movable through the body of water (12) from its transportation position to an intervention position wherein the baseplate (88) is applied under a lower surface (42) of the offshore wind turbine platform (14), the maximum axial dimension of each horizontal section of the buoyant body (86), taken along the fastening axis (A-A′), being less than 90% of the maximum dimension of the offshore wind turbine platform (14), taken parallel to the same fastening axis (A-A′).

16. The offshore facility according to claim 15, wherein the offshore wind turbine platform (14) comprises a floating foundation (16) having at least three floating columns (22) and lower pontoons (26A), connecting two-by-two the at least three floating columns (22), the lower pontoons (26A) defining at least a part of the lower surface (42) of the floating wind turbine platform (14), the upper contact surface (94) of the baseplate (88) being engaged under the lower surface of a lower pontoon (26A) between two adjacent floating columns (22), the maximum transverse dimension of each horizontal section of the buoyant body (86) being less than the distance horizontally separating the two adjacent floating columns (22) or comprises a floating foundation formed from a barge with or without a central hole.
